(19) United States
(12) Patent Application Publication
(10) Pub. No.: US 2023/0250219 A1
(43) Pub. Date: Aug. 10, 2023

(54) Thermoplastic polyurethane composition with high mechanical properties, good resistance against UV radiation and low blooming and fogging

(71) Applicant: BASF SE, Ludwigshafen am Rhein (DE)

(72) Inventors: Oliver Steffen HENZE, Lemfoerde (DE); Dirk Kempfert, Lemfoerde (DE); Rebecca Spreen, Lemfoerde (DE); Tanja Lange, Lemfoerde (DE)

(73) Assignee: BASF SE, Ludwigshafen am Rhein (DE)

(21) Appl. No.: 18/001,700

(22) PCT Filed: Jun. 7, 2021
(86) PCT No.: PCT/EP2021/065164

§ 371 Date: Dec. 13, 2022

(30) Foreign Application Priority Data
Jun. 15, 2020 (EP) 20179911.1

(51) Int. Cl. C08G 18/73; C08G 18/44; C08G 18/32; C08K 7/14; C08K 7/20

(52) U.S. Cl. CPC C08G 18/73; C08G 18/44; C08G 18/3206; C08K 7/14; C08K 7/20

(57) ABSTRACT

A composition contains thermoplastic polyurethane, which is the reaction product of a pentamethylene diisocyanate, a polycarbonate diol, and a chain extender. The composition is useful for producing articles. A production process for producing a filled composition involves adding glass to the composition. Articles can be derived from the composition and the filled composition.

Thermoplastic polyurethanes are well known in the art. Whereas for a lot of applications, there are specific demands that must be fulfilled beside the demand for high mechanical performance. US 2009/0292100 A1 discloses a process for preparing pentamethylene 1,5-diisocyanate.

The problem to be solved by the current application was to provide a thermoplastic polyurethane with good resistance against UV radiation and low blooming and fogging in addition to good mechanical properties.

Surprisingly this could be achieved by thermoplastic polyurethane mainly based on penta-methylene diisocyanate.

One aspect of this invention is embodiment 1, a composition comprising thermoplastic polyurethane being the reaction product of the following components
i. diisocyanate
ii. compound reactive toward isocyanate
iii. chain extender
   wherein the diisocyanate is penta-methylene diisocyanate and the compound reactive toward isocyanate comprises polycarbonate diol, preferably is polycarbonate diol.

### ADVANTAGES

The advantage of the composition according to this invention is the overall good mechanical properties combined with high resistance against radiation, especially UV radiation, and low blooming respectively fogging. These properties are more distinct in the preferred embodiments outlined below.

Further advantages of the composition according to this invention is that penta-methylene diisocyanate itself may be produced bio-based and which allows the composition to be at least regarding the isocyanate bio-based. Bio-based does mean that the respective components of the composition do not derive from mineral oil. Bio-based, whereas is not restricted to the isocyanate component, but may refer to the other components of the product as well, or further additives or auxiliaries of the composition.

Bio-based substance is made from substances derived from living organisms. In a preferred embodiment in a bio-based substance more than 50 weight % of its molecules are from living organism, preferably more than 55 weight %, preferably more than 60 weight %, preferably more than 65 weight %, preferably more than 70 weight %, preferably more than 75 weight %, preferably more than 80 weight %, preferably more than 85 weight %, more preferred more than 90 weight %, preferably more than 95 weight %, most preferred more than 99 weight %.

In a preferred embodiment 2 comprising all the features of embodiment 1 or one of its preferred embodiments, the penta-methylene diisocyanate is at least partly bio-based, most preferred all the penta-methylene diisocyanate is bio-based.

In a preferred embodiment 3 in the composition according to precedent embodiments or one of its preferred embodiments the compound reactive towards isocyanate comprises, preferably is, a polyol, more preferably a diol, preferably selected from the group consisting of polycarbonate diol, polyether diol, or a polyester diol, or is a mixture thereof. In a preferred embodiment according to the invention the compound reactive towards isocyanate comprises polycarbonate diol, more preferably is polycarbonate diol. If the compound reactive towards isocyanate comprises polycarbonate diol, the polycarbonate diol preferably is present in an amount of 10 weight-% referring to the whole amount of compound reactive towards isocyanate, which is 100 weight-%, more preferably the polycarbonate diol is present in an amount of more than 20 weight %, more preferably more than 30 weight-%, more preferably more than 40 weight-%, more preferably more than 50 weight-%, more preferably more than 60 weight-%, more preferably more than 70 weight-%, more preferably more than 80 weight-%, more preferably more than 90 weight-%, more preferably more than 95 weight-%.

The compound reactive towards isocyanate preferably has a number-average molecular weight (Mn) of more than 500 g/Mol, preferably in the range of 500 g/Mol to 4×103 g/Mol, preferably determined by GPC method, more preferably according to DIN 55672-1: 2016-03, further preferred in the range of 0.65×103 g/Mol to 3.5×103 g/Mol, especially preferred in the range of 0.8×103 g/Mol to 3.0×103 g/Mol, all preferably determined by said GPC method.

### Polycarbonatdiol

Preferably the polycarbonate diol is an aliphatic polycarbonate diol. Preferred polycarbonate diols are polycarbonate diols deriving from alkane diols. Preferably these polycarbonate diols are strictly difunctional polycarbonate diols with OH being the functional group. Further preferred the alkane diol is selected from butanediol, pentanediol or hexanediol, or is a mixture thereof. Further preferred the alkane diol is selected from the group of 1,3-propanediol, 1,4-butanediol, 1,5-pentanediol, 1,6-hexanediol, 3-methylpentane-(1,5)-diol, or is a mixture thereof. More preferred the alkane diol is selected from 1,3-propandiol, 1,4-butanediol, 1,5-pentanediol, 1,6-hexanediol, or is a mixture thereof. More preferred the alkan diol is selected from 1,3-propandiol, 1,4-butandiol, or is a mixture thereof. Most preferred the alkane diol is 1,4-butanediol. These diols preferably are bio-based.

In a preferred embodiment the polycarbonate is the reaction product of the above mentioned diol and dimethyl carbonate. The polycarbonate diol preferably is received by transesterification in a reaction mixture of dimethyl carbonate with the respective diol, where the ethanol is removed from the reaction mixture, preferably by distillation.

In preferred embodiments at least one of the following polyols, or a mixture thereof is part of the compound reactive with isocyanate

### Polyether

The polyether preferably is a polymer of 1,3-propandiol or 1,4-butandiol, or is a mixture thereof, preferably 1,3-propandiol or 1,4-butandiol. Preferable the polyether has a number average molecular weight in the range of 500 g/Mol to 4×10³ g/Mol, preferably determined by GPC method, more preferably according to DIN 55672-1: 2016-03, further preferred in the range of 0.65×103 g/Mol to 3.5×103 g/Mol, further preferred in the range of 0.8×103 g/Mol to 2.2×103 g/Mol, especially preferred in the range of 0.8×103 g/Mol to 1.2×103 g/Mol, all preferably determined by said GPC method. The polyether derived from 1,4-butandiol in one preferred embodiment is polytetrahydrofuran. Most preferred is poly-1,4-butandiol.

### Polyester

The polyester preferably is derived from a diol and dicarboxylic acid.

This diol of the polyester preferably is 1,3-propanediol, or 1,4-butanediol, or is a mixture thereof.

Even more preferred the diol is bio-based as outlined above.

The dicarboxylic acid preferably is selected from the group consisting of sebacic acid, azelaic acid, dodecanedioic acid and succinic acid, or is a mixture thereof. More preferred the dicarboxylic acid is succinic acid or sebacic acid, most preferred sebacic acid.

In more preferred embodiments the dicarboxylic acid is bio-based as outlined above.

### Chain Extender

In a preferred embodiment 4, comprising all features of one of the precedent embodiments or one of its preferred embodiments, the chain extender comprises, preferably is, 1,2-ethanediol, 1,3-propanediol, 1,3-methylpropanediol, 1,4-butanediol, or 1,6-hexanediol, or a mixture thereof.

More preferably the chain extender is selected from the group consisting of 1,3-propanediol, 1,4-butanediol, or 1,6-hexanediol, or is a mixture thereof. More preferably the chain-extender is bio-based as outlined above.

A very preferred chain extender comprises, more preferred is a mixture of 1,3-propanediol and 1,4-butanediol. More preferred the ratio of the 1,3-propanediol and 1,4-butandiol in any of these embodiments is between 0.1:0.9 and 0.4:0.6.

In a preferred embodiment 5, comprising all features of one of the precedent embodiments or one of its preferred embodiments, the composition has a hardness of less than 95 Shore A, determined according to DIN ISO 7619-1: 2016, more preferably less than 90 Shore A, more preferable less than 85 Shore A, more preferable less than 82 Shore A, and more preferable less than 78 Shore A. In other preferred embodiments the Shore A hardness is 80 Shore A to 100 Shore A, preferably 85 shore A to 95 shore A, more preferred 90 Shore A to 95 Shore A, preferably measured according to DIN ISO 7619-1: 2016. The latter ranges are preferably use for covers, preferably covers used for electric device, more preferably for electric device receiving or sending electromagnetic waves. In one preferred embodiment these rages apply for covers of mobile phones.

### Catalyst

In a preferred embodiment 6, comprising all features of one of the precedent embodiments or one of its preferred embodiments, the reaction product is formed in the presence of a catalyst and therefore the composition further comprises a catalyst. This is in particular a catalyst which accelerates the reaction between the NCO groups of the isocyanate (a) and the isocyanate-reactive compound, preferably with hydroxyl groups and, if used, the chain extender. The preferred catalyst is selected from the group consisting of tertiary amines, especially triethylamine, dimethylcyclohexylamine, N-methylmorpholine, N,N′-dimethylpiperazine, 2-(dimethylaminoethoxy)-ethanol, diazabicyclo-(2,2,2)-octane, or are mixtures thereof, or are selected from group consisting of metal compounds, preferably titanium acid esters, iron compounds, preferably ferric acetylacetonate, tin compounds, preferably those of carboxylic acids, particularly preferred tin diacetate, tin dioctoate, tin dilaurate or tin dialkyl salts, further preferred dibutyltin diacetate, dibutyltin dilaurate, or from the group consisting of bismuth salts of carboxylic acids, preferably bismuth(III) neodecanoate, or is a mixture thereof.

The catalyst preferably is selected from the group consisting of tin dioctoate, bismuth decanoate, titanic acid ester, or is a mixture thereof. A preferred tin dioctoate is tin (II) 2-ethylhexanoate.

### Auxilliaries

In a preferred embodiment 7, comprising all features of one of the precedent embodiments or one of its preferred embodiments, the composition further comprises an auxiliary or additive.

Preferred examples include surface-active substances, fillers, flame retardants, nucleating agents, oxidation stabilizers, lubricating and demolding aids, dyes and pigments, if necessary, stabilizers, preferably against hydrolysis, light, heat or discoloration, inorganic and/or organic fillers, reinforcing agents and/or plasticizers.

Stabilizers in the sense of this invention are additives which protect a plastic or a plastic composition against harmful environmental influences. Preferred examples are primary and secondary antioxidants, sterically hindered phenols, hindered amine light stabilizers, UV absorbers, hydrolysis inhibitors, quenchers and flame retardants. Examples of commercial stabilizers are given in Plastics Additives Handbook, 5th Edition, H. Zweifel, ed., Hanser Publishers, Munich, 2001 ([1]), p.98-S136.

In a preferred embodiment, the UV absorber has a number average molecular weight greater than 0.3×103 g/Mol, in particular greater than 0.39×103 g/Mol. Furthermore, the preferred UV absorber has a molecular weight not exceeding 5×103 g/Mol, particularly preferred not exceeding 2×103 g/mol.

The UV absorber is preferably selected from the group consisting of cinnamates, oxanilides and benzotriazole, or is a mixture thereof, particularly suitable as UV absorbers is benzotriazole. Examples of particularly suitable UV-absorbers are Tinuvin® 213, Tinuvin® 234, Tinuvin® 312, Tinuvin® 571, Tinuvin® 384 and Eversorb® 82.

Preferably the UV absorbers is added in quantities of 0.01 wt. % to 5 wt. % based on the total weight of the compositon, preferably 0.1 wt. % to 2.0 wt. %, in particular 0.2 wt. % to 0.5 wt. %.

Often a UV stabilization based on an antioxidant and a UV absorber as described above is not sufficient to guarantee a good stability of the composition against the harmful influence of UV rays. In this case, in addition to the antioxidant and/or the UV absorber, or as single stabilizer, a hindered-amine light stabilizer (HALS) is be added to the composition.

Examples of commercially available HALS stabilizers can be found in Plastics Additive Handbook, 5th edition, H. Zweifel, Hanser Publishers, Munich, 2001, pp. 123-136.

Particularly preferred hindered amine light stabilizers are bis-(1,2,2,6,6-penta-methylpiperidyl) sebacat (Tinuvin® 765, Ciba Spezialitatenchemie AG) and the condensation product of 1-hydroxyethyl-2,2,6,6-tetramethyl-4-hydroxypiperidine and succinic acid (Tinuvin® 622). In particular, the condensation product of 1-hydroxyethyl-2,2,6,6-tetramethyl-4-hydroxypiperidines and succinic acid (Tinuvin® 622) is preferred, if the titanium content of the finished product is less than 150 ppm, preferably less than 50 ppm, in particular less than 10 ppm, based on the components used.

HALS compounds are preferably used in a concentration of from 0.01 wt. % to 5 wt. %, particularly preferably from 0.1 wt. % to 1 wt. %, in particular from 0.15 wt. % to 0.3 wt. %, based on the total weight of the composition.

A particularly preferred UV stabilization contains a mixture of a phenolic stabilizer, a benzotriazole and a HALS compound in the preferred amounts described above.

Further information on the above-mentioned auxiliaries and additives can be found in the technical literature, e.g. Plastics Additives Handbook, 5th edition, H. Zweifel, ed., Hanser Publishers, Munich, 2001.

### Fillers

In a preferred embodiment 8, comprising all features of one of the precedent embodiments or one of its preferred embodiments, the composition comprises at least a filler as an additive. The advantage of fillers is to reduce warpage, preferably during injection molding.

The advantage of adding glass is inter alia a better processability, less stickiness, better demoulding behavior, and less shrinkage of the composition. Especially in combination with polycarbonate diol, the composition also shows better resetting behavior.

Preferred fillers are glass fibers, glass beads, preferably hollowed glass beads, carbon fibers, aramid fibers, potassium titanate fibers, fibers made from liquid-crystalline polymers, organic fibrous fillers or inorganic reinforcing materials.

Preferred organic fibrous fillers are fibers selected from the group of cellulose, hemp, Sisal, or Kenaf, or are mixtures thereof.

Preferred inorganic reinforcing material is selected from the group of ceramic, preferably aluminum or boron nitride, or minerals, such as asbestos, talc, wollastonite, Microvit, silicates, chalk, calcined kaolins, mica, and quartz powder.

The fibers preferably have a diameter of 3 μm to 30 μm, preferably 6 μm to 20 μm and particularly preferably from 8 μm to 15 μm. The fiber length in the compounded material is preferable 20 μm to 1 mm, preferably 180 μm to 500 μm and particularly preferably 200 μm to 400 μm.

In another preferred embodiment the glass has the form of a sphere, preferably a hollowed sphere.

Suitable and preferred are for example hollow glass spheres prepared using borosilicate glass, further preferred soda-lime borosilicate glass.

Glass spheres are commercially available e.g. from 3M Speciality Materials: GLASS BUBBLES IM16K, Target crush strength (90% survival): 16000psi, true density of 0.46 g/cm³, particle size distribution (10%) 3M QCM 193.2: 12 μm by volume, particle size distribution (50%) 3M QCM 193.2: 20 μm by volume, particle size distribution (90%) 3M QCM 193.2: 30 μm by volume, effective top size, 3M QCM 193.2: 40 μm by volume, alkalinity<0.5 meq/g.

The diameter of the glass spheres can vary in wide ranges. Preferred spheres, also referred to as microspheres have an average diameter from 5 μm to 100 μm, preferably in the range of from 10 μm to 75 μm, more preferable in the range of from 20 μm to 50 μm, for example in a range of from 20 μm to 40 μm.

It has been found that it is particularly advantageous to use the hollow glass microspheres in an amount of from 1 weight % to 25 weight % referring to the whole composition. more preferably from 2 weight % to 15 weight %, in particular from 5 weight % to 10 weight %.

Another preferred filler is starch or cellulose. These fillers improve compostability of the composition, if desired.

Another preferred filler is a powder, preferably an inorganic powder, more preferably selected from the group of BaSO₄, CaCO₃, carbon black, TiO₂. Any other filler, that reduces warpage during injection moulding is also preferred.

### Flame retardants

The composition of the present invention in one preferred embodiment 9, comprising all the features of one of the precedent embodiments or one of its preferred embodiments, also comprises a flame retardant.

A preferred kind of flame retardant is a nitrogen based compound selected from the group consisting of, melamine cyanurate, melamine polyphosphate, melamine pyrophosphate, melamine borate, condensation product of melamine selected from the group consisting of melem, melam, melon and higher condensed compounds and other reaction products of melamine with phosphoric acid, melamine derivatives .

Another kind of flame retardant is an inorganic flame retardant and is preferably selected from the group consisting of magnesium hydroxide and aluminum hydroxide.

Yet another kind of flame retardant is a phosphorus containing flame retardant. The phosphorus containing flame retardant preferably is liquid at 21° C.

Preference is given to derivatives of the phosphoric acid, derivatives of the phosphonic acid, or derivatives of the phosphinic acid, or a mixture of two or more of said derivatives.

The composition is preferably in the form of granules or is a powder.

### e-TPU

In another preferred embodiment 10, the composition comprising all feature of one of the precedent embodiments or one of its preferred embodiments, is in the form of foamed beads

Foam beads, and also moulded bodies produced therefrom, based on thermoplastic polyurethane or on other elastomers are known and have many possible uses (see e.g. WO 94/20568, WO 2007/082838 A1, WO2017030835, WO 2013/153190 A1, WO2010010010).

The term foamed bead is also referred to as foam bead. The average diameter of the foamed bead, preferably is from 0.2 mm to 20 mm, preferably from 0.5 mm to 15 mm and in particular from 1 mm to 12 mm. When foam beads are not spherical, e.g. are elongate or cylindrical, diameter means the longest dimension.

The bulk density of the foam beads of the invention is preferably from 50 g/L to 200 g/L, preferably from 60 g/L to 180 g/L, particularly preferably from 80 g/L to 150 g/L. Bulk density is measured preferably with the method according to DIN ISO 697, wherein a vessel with volume of 10 L is used instead of a vessel with a volume of 0.5 L. This is because a measurement using a volume of only 0.5 l is too imprecise specifically when the foam beads have low density and high mass.

### Production Process

Another aspect of the invention and embodiment 11 is the production of the composition comprising a thermoplastic polyurethane according to any of the precedent embodiments, or one their preferred embodiments. In a preferred embodiment the composition is produced discontinuously or continuously. A preferred process. is the reaction extruder process, the belt line process, the “one shot” process, preferably the “one-shot” process or the reaction extruder process, most preferably the reaction extruder process.

These processes are used either by directly mixing the building components or alternatively by applying the prepolymer process.

Polyisocyanate prepolymers are obtainable by reacting above-described polyisocyanate in excess, at temperatures of 30° C. to 100° C., preferably at 8×102° C., with the compound reactive toward isocyante, preferably the polyol.

In the “one-shot” process, the building components diisocyanate and diol, and in a preferred embodiment also the chain extender, are mixed with each other. This is done either in succession or simultaneously, in preferred embodiment in the presence of the catalyst and/or an auxiliary. In the extruder process, the building components diisocyanate and diol, in a preferred embodiment also the chain extender, and, in further preferred forms, also the catalyst and/or the auxiliary are mixed. The mixing in the reaction extruding process is done preferably at temperatures between 100° C. and 280° C., preferably between 140° C. and 250° C. The thermoplastic polyurethane obtained, preferably is in the form of a granulate or a powder.

The auxiliaries in one embodiment are added during synthesis of the polyisocyanate polyaddition product, preferably the thermoplastic polyurethane. In another preferred embodiment the auxiliary (e) is added to the polyisocyanate polyaddition product, preferably the thermoplastic polyurethane after its synthesis, preferably in an extruder.

A twin-screw extruder is preferred, as the twin-screw extruder operates with positive conveying and thus allows a more precise setting of the temperature and output quantity on the extruder.

The mixture comprising the polyisocyanate polyaddition product, preferably the thermoplastic polyurethane, eventually at least one auxiliary and/or additive and in preferred embodiments further polymers is also referred to as composition

In a preferred embodiment 12 comprising all features of embodiment 11 or one of its preferred embodiments, the auxiliary glass is added to the composition.

### e-TPU process

In one preferred embodiment 13 foam beads are produced by providing the composition according to one of the precedent embodiments or one of its preferred embodiments by impregnating the composition with a blowing agent under pressure; and expanding the composition by means of pressure decrease, in a preferred embodiment the impregnated beads are heated, to allow foaming.

Preferred blowing agents in this process variant are volatile organic compounds with boiling point from −25° C. to 150° C. at atmospheric pressure of 1013 mbar, in particular from −10° C. to 125° C. Beside water , hydrocarbons have good suitability, in particular C4-C10-alkanes, preferably the isomers of butane, of pentane, of hexane, of heptane, of octane, and of isopentane, particularly preferably of isopentane.

Other preferred blowing agents are moreover bulkier compounds or functionalized hydrocarbons, preferred examples are alcohols, ketones, esters, ethers and organic carbonates.

Preferred examples of suitable hydrocarbons are halogenated or non-halogenated, saturated or unsaturated aliphatic hydrocarbons, preferably non-halogenated, saturated or unsaturated aliphatic hydrocarbons.

Beside water, preferred blowing agents for foaming beads are organic liquids and gases which are in a gaseous state under the processing conditions, for example hydrocarbons or inorganic gases, or mixtures of organic liquids and, respectively, gases and of inorganic gases, where these can likewise be combined.

In a preferred embodiment the blowing agent is halogen-free.

Preferred organic blowing agents are saturated, aliphatic hydrocarbons, in particular those having from 3 to 8 carbon atoms, for example butane or pentane.

Suitable inorganic gases are nitrogen, air, ammonia and carbon dioxide, preferably nitrogen or carbon dioxide, and mixtures of the abovementioned gases.

Foaming of the beads in one preferred embodiment is conduct in suspension as described e.g. in WO2007/082838, herein incorporated by reference.

In one preferred embodiment the foaming of beads is done by extrusion as described e.g. in WO 2007/082838, or in WO 2013/153190 A1, herein incorporated by reference.

Alternatively, in the methods described in WO2014150122 or WO2014150124 A1, herein incorporated by reference, it is possible to produce the corresponding foam bead, which may be coloured, directly from the pellets in that the corresponding pellets are impregnated with a supercritical liquid and are removed from the supercritical liquid, this being followed by

(i) the product being immersed in a heated fluid or

(ii) the product being irradiated (for example with infrared or microwave radiation).

Examples of suitable supercritical liquids are those described in WO2014150122, herein incorporated by reference, preferably carbon dioxide, nitrogen dioxide, ethane, ethylene, oxygen or nitrogen, more preferably carbon dioxide or nitrogen.

The supercritical liquid in a preferred embodiment comprises a polar liquid with a Hildebrand solubility parameter equal to or greater than 9 MPa^{1/2}.

The present invention also includes a moulded body produced from the foam beads of the invention as e.g. describe in EP1979401B1), or radiation (microwaves or radio waves).

The temperature during the fusion of the foam beads is in the vicinity of, the melting point, preferably below the melting point of the polymer from which the foam bead has been produced. For the polymers commonly used, the temperature for the fusion of the foam beads is accordingly from 100° C. to 180° C., preferably from 120 to 150° C.

Temperature profiles/residence times can be determined individually, preferably on the basis of the processes described in EP2872309B1.

The fusion by way of radiation generally can be achieved by a method based on the processes described in EP3053732A and WO16146537.

In one embodiment, the beads produced are coloured during or after production. e.g. as described in WO 2019/081644 herein incorporated by reference.

Preferred examples of suitable colorants are inorganic and organic pigments. Preferred examples of suitable natural or synthetic inorganic pigments are carbon black, graphite, titanium oxides, iron oxides, zirconium oxides, cobalt oxide compounds, chromium oxide compounds, copper oxide compounds. Examples of suitable organic pigments are azo pigments and polycyclic pigments.

In another preferred embodiment the supercritical liquid or the heated liquid comprises a colorant. Details are described in WO 2014/150122, herein incorporated by reference.

### Use

In a preferred embodiment 14, the composition according to one of embodiments 1 to 10 or its preferred embodiment, respectively the process according to embodiments 11 to 13 or their preferred embodiments is in the form of a pellet or a powder.

The pellet or powder in a preferred embodiment is a compact material. In another preferred embodiment the pellet is expanded material, also referred to as foamed beads or foam beads.

Another aspect of this invention and embodiment 15 is a foamed bead made of the preparation according to one of claims 1 to 10 or its preferred embodiments or as obtained according to one of embodiments 11 to 13 or its preferred embodiments.

These foamed beads and also molded bodies produced therefrom may be used in various applications (see e.g. WO 94/20568, WO 2007/082838 A1, WO2017030835, WO 2013/153190 A1, WO2010010010), herein incorporated by reference

Another aspect of the invention, also referred to as embodiment 16, is the use of the preparation according to one of embodiments 1 to 10, or its preferred embodiment, or as obtained according to one of embodiments 11 to 13, or its preferred embodiments, for producing an article.

The production of these articles is preferably done by injection moulding, calendering, powder sintering or extrusion.

The composition in a preferred embodiment is injection moulded, calendered, powder sintered, or extruded to form an article.

Yet another aspect of the invention, also referred to as embodiment 17, is the article produced with a composition according to one of embodiments 1 to 10, or its preferred embodiments, or as obtained by the process according to one of embodiments 11 to 13 or its preferred embodiments.

The article in further preferred embodiments is selected from, coating, damping element, bellows, foil, fibre, moulded body, roofing or flooring for buildings or vehicles, non-woven fabric, gasket, roll, shoe sole, hose, cable, cable connector, cable sheathing, pillow, laminate, profile, strap, saddle, foam, by additional foaming of the preparation, plug connection, trailing cable, solar module, lining in automobiles, wiper blade, elevator load bearing members, roping arrangements, drive belts for machines, preferably passenger conveyer, handrails for passenger conveyers modifier for thermoplastic materials, which means substance that influences the properties of another material. Each of these articles itself is a preferred embodiment, also referred to as an application.

In a preferred embodiment the composition according to any one of the precedent embodiments or its preferred embodiments is used for products, preferably those products exposed to UV radiation.

Preferably these products are selected from the group consisting of cable, cases, cell-phone, coating, covers, damping element, bellows, foil, fibre, moulded body, roofing or flooring for buildings or vehicles, non-woven fabric, gasket, packaging material, roll, shoe sole, hose, cable, cable connector, cable sheathing, pillow, laminate, phone, profile, strap, saddle, foam, by additional foaming of the preparation, plug connection, television, trailing cable, solar module, lining in automobiles, wiper blade, elevator load bearing members, roping arrangements, drive belts for machines, preferably passenger conveyer, handrails for passenger conveyers modifier for thermoplastic materials, which means substance that influences the properties of another material. Each of these articles itself is a preferred embodiment, also referred to as an application.

More preferably the product is selected from covers, packaging material, cases, phone, cell phones, television, or cable, more preferably for electronic device.

The invention also includes the use of foam beads of the invention for the production of a moulded body for shoe intermediate soles, shoe insoles, shoe combi-soles, bicycle saddles, bicycle tyres, damping elements, cushioning, mattresses, underlays, grips, and protective films, in components in the automobile-interior sector and automobile-exterior sector, in balls and sports equipment, or as floorcovering, in particular for sports surfaces, running tracks, sports halls, children's play areas and walkways.

### EXAMPLES

### Example 1: Materials

Chopvantage HP3550 EC10-3,8: Glass fiber from PPG Industries Fiber Glass, Energieweg 3, 9608 PC Westerbroek, The Netherlands. E-Glass, diameter of the filaments 10pm, length 3,8mm.

iMK16 Glass bubbles: from 3M Speciality Materials: GLASS BUBBLES IM16K, Target 10 crush strength (90% survival): 16000psi, true density of 0,46 g/cm3, particle size distribution (10%) 3M QCM 193.2: 12pm by volume, particle size distribution (50%) 3M QCM 193.2: 20pm by volume, particle size distribution (90%) 3M QCM 193.2: 30pm by volume, effective top size, 3M QCM 193.2: 40pm by volume, alka15 linity <0.5 meq/g.

Poly PTHF® 1000: Polytetrahydrofurane 1000, CAS-No. 25190-06-1, BASF SE, 67056 Ludwigshafen, Germany.

1,4-Butanediol: Butan-1,4-diol, CAS-No. 110-63-4, BASF SE, 67056 Ludwigshafen, Germany.

1,3-Propanediol: Propan-1,3-diol, CAS-No. 504-63-2, DuPont Tate and Lyle.

Polyesterol 2000: Polyol with a molecular weight Mn of 2000 Dalton based on adipic acid, 1,6hexanediol and 1,4 butanediol in a molar ratio of 0.5: 0.5.

TPU 1 (VB): A TPU with a hardness of 90 Shore A based on HDI (268 g), Polyesterol 2000 (1000 g), and 1,4-Butandiol (98 g).

TPU 2 (VB): A TPU with a hardness of 90 Shore A based on 1,6-hexamethylenediisocyanat (HDI, CAS-No. 822-06-0, 382 g), Poly PTHF® 1000 (1000 g), and 1,4-Butandiol (114 g).

TPU 3 (VB): A TPU with a hardness of 80 Shore A based on HDI (268 g), Poly PTHF® 1000 (1000 g), and 1,4-Butandiol (53 g).

TPU 4 (EB): A TPU with a hardness of 90 Shore A based on PDI (260 g), Polyesterol 2000 (1000 g), and 1,4-Butandiol (107 g).

TPU 5 (EB): A TPU with a hardness of 90 Shore A based on 1,5-pentamethylenediisocyanat (PDI, CAS-No. 4538-42-5, 360 g), Poly PTHF® 1000 (1000 g), and 1,4-Butandiol (120 g).

TPU 6 (EB): A TPU with a hardness of 80 Shore A based on PDI (258 g), Poly PTHF® 1000 (1000 g), and 1,4-Butandiol (61 g).

TPU 7 (EB): A mixture made from 90 weight % TPU 4 und 10 weight % Chopvantage HP3550 EC10-3,8 with a hardness of 90 Shore A.

TPU 8 (EB): A mixture made from 90 weight % TPU 4 und 10 weight % Chopvantage HP3550 EC10-3,8 with a hardness of 95 Shore A.

TPU 9 (EB): A mixture made from 90 weight % TPU 4 und 10 weight % iMK16 Glass bubbles with a hardness of 88 Shore A.

TPU 10 (EB): A TPU with a hardness of 90 Shore A based on PDI (360 g), Poly PTHF® 1000 (1000g), and a mixture of 1,4-Butandiol (105g) with 1,3-propanediol (13g) in molar proportions of 0.85:0.15.

TPU 11 (EB): A TPU with a hardness of 90 Shore A based on PDI (260 g), Eternacoll PH-200D (1000 g), and 1,4-Butandiol (107 g).

### Example 2 Preparation of Polymers by Hand Casting

The polyols were placed in a container at 80° C. and mixed with the components according to the amounts given above under vigorous stirring in a reaction vessel. The isocyanate was added at last component. As soon as a reaction temperature of 110° C. was reached or the foam-level exceeded 80% of the reaction vessel volume. The reaction mixture was poured on a heating plate (120° C.) forming a slab. The slab was cured onto the plate for 10 min, afterwards tempered at 80° C. for 15 h, crushed and extruded into granules.

The extrusion was carried out on a twin-screw extruder with a strand diameter of approx. 2 mm. Extruder: co-rotating twin screw extruder, APV MP19

Temperature profile:
Heating zone HZ1 (feeding zone) 175° C. to 185° C.
Heating zone HZ2 180° C. to 190° C.
Heating zone HZ3 185° C. to 195° C.
Heating zone HZ4 185° C. to 195° C.
Heating zone HZ5 (nozzle) 180° C. to 190° C.
Screw speed: 100 rpm
Pressure: approx. 10 to 30 bar
Strand cooling: Water bath (10° C.)

The obtained granulate was reshaped by injection molding into 2 mm thick test plates. The temperature of the melt during the production of the test plates did not exceed 250° C.

### Example 3: Description of the Storage Testing

Deposits on the surface (blooming) are unacceptable for many applications. Storage tests can help to predict whether deposits will be formed or not.

Storage test 1: The specimens, heated at 100° C. for 20 h were stored under standard conditions of temperature and humidity (23° C., 50% r.h.).

Storage test 2: The unheated specimens were stored under standard conditions of temperature and humidity (23° C., 50% r.h.).

Storage test 3: The specimens, heated at 100° C. for 20 h were stored in an oven at 80° C.

Storage test 4: The unheated specimens were stored in an oven at 80° C.

### Example 4: Results of the Storage Testing

| | | 1 | 2 | 3 | 4 | 5 | 6 | 7 | 8 | 9 | 10 | 11 |
|---|---|---|---|---|---|---|---|---|---|---|---|---|
| TPU | | (VB | (VB) | (VB) | (EB) | (EB) | (EB) | (EB) | (EB) | (EB) | (EB) | (EB) |
| Shore Hardness | | 90 | 90 | 80 | 90 | 90 | 80 | 90 | 95 | 88 | 90 | 90 |
| Polyesterol 2000 | | X | | | X | | | | | | | |
| PTHF 1000 | | | X | X | | X | X | X | X | X | X | |
| Eternacoll PH 200D | | | | | | | | | | | | X |
| 1,4-Butanediol | mol- | 100 | 100 | 100 | 100 | 100 | 100 | 100 | 100 | 100 | 85 | 100 |
| 1,3-Propanediol | mol- | 0 | 0 | 0 | 0 | 0 | 0 | 0 | 0 | 0 | 15 | 0 |
| | % | | | | | | | | | | | |
| PDI | | | | | X | X | X | X | X | X | X | X |
| HDI | | X | X | X | | | | | | | | |
| Chopvantage HP3550 | % | | | | | | | 10 | 20 | | | |
| EC10-3,8 (glas fiber) | | | | | | | | | | | | |
| iMK16 | % | | | | | | | | | 10 | | |
| (glas bubbles | | | | | | | | | | | | |
| Storage test 1 | 21 d | D. | D. | D. | W. D. | W.D. | W. D. | W. D. | W. D. | W. D. | W. D. | W. D. |
| Storage test 1 | 42 d | D. | D. | D. | W. D. | W. D. | W. D. | W. D. | W. D. | W. D. | W. D. | W. D. |
| Storage test 2 | 21 d | D. | D. | D. | W. D. | W. D. | W. D. | W. D. | W. D. | W. D. | W. D. | W. D. |
| Storage test 2 | 42 d | D. | D. | D. | W.D. | W. D. | W. D. | W. D. | W. D. | W. D. | W. D. | W. D. |
| Storage test 3 | 21 d | D. | D. | D. | W. D. | W. D. | W. D. | W. D. | W. D. | W. D. | W. D. | W. D. |
| Storage test 3 | 42 d | D. | D. | D. | D. | D. | W. D. | W. D. | W. D. | W. D. | W. D. | W. D. |
| Storage test 4 | 21 d | D. | D. | D. | W. D. | W. D. | W. D. | W. D. | W. D. | W. D. | W. D. | W. D. |
| Storage test 4 | 42 d | D. | D. | D. | D. | D. | W. D. | W. D. | W. D. | W. D. | W. D. | W. D: |

D.: deposit
W. D.: without deposit

TPU 1-2 (comparative example VB) are based on HDI with a hardness of 90 Shore A. All storage tests show deposits.

TPU 3 (VB) is based on HDI with a reduced Shore hardness of 80A. All storage tests show deposits.

TPU 4-5 (inventive example EB) are based on PDI with a hardness of 90 Shore A and show reduced blooming compared to TPU 1-3.

TPU 6 (EB) is based on PDI with a hardness of 80 Shore A. The reduced hardness compared to TPU 4 and 5 results in a further reduced blooming.

TPU 7-9 (EB) are based on TPU 6. Fillers (glass fiber and glass bubbles) were added to increase the hardness. TPU 7-9 have an increased Shore hardness of 90 Shore A but show reduced blooming compared to TPU 1 and 2.

TPU 10 (EB) is based on PDI with a hardness of 90 Shore A. In comparison to TPU 5 this TPU is based on a mixture of chain extenders. TPU 10 shows reduced blooming, compared to TPU 5.

TPU 11 (EB) are based on PDI and with a hardness of 90 Shore A. In comparison to TPU 5 this TPU is based on a polycarbonate polyol. TPU 11 shows reduced blooming, compared to TPU 5.

1. A composition comprising:
thermoplastic polyurethane, which is a reaction product of the following components;
i. diisocyanate,
ii. compound reactive toward isocyanate, and
iii. chain extender
wherein the diisocyanate is pentamethlyene diisocyanate and the compound reactive toward isocyanate comprises polycarbonate diol.

2. The composition according to claim 1, wherein the chain extender comprises ethanediol, 1,3-propanediol, 1,4-butanediol, or 1,6-hexanediol, or comprises a mixture thereof.

3. The composition according to claim 1, wherein the composition has a hardness of less than 95 Shore A, determined according to DIN ISO 7619-1: 2016.

4. The composition according to claim 1, wherein the composition further comprises an additive.

5. The composition according to claim 4, wherein the additive is glass and wherein the glass is in form of a fiber or a sphere.

6. The composition according to claim 1, wherein the isocyanate, the polycarbonate diol, or the chain extender, or a mixture thereof is bio-based.

7. A method comprising:
producing an article with the composition according to claim 1, by injection moulding, calendering, powder sintering, or extrusion.

8. A process for the production of a filled composition the process comprising:
adding glass to the composition according to claim 1.

9. An article, produced from the composition according to claim 1.

10. The composition according to claim 2, wherein the chain extender comprises 3-propanediol, 1,4-hutanediol, or a mixture thereof.

11. The composition according to claim 3, wherein the composition has a hardness of less than 85 Shore A, determined according to DIN ISO 7619-1: 2016.

12. The composition according to claim 4, wherein the additive is glass.

13. The composition according to claim 6, wherein the isocyanate is bio-based

14. An article, produced from the filled composition obtained by the process according to claim 8.
